(19) United States
(12) Patent Application Publication
(10) Pub. No.: US 2016/0238222 A1
(43) Pub. Date: Aug. 18, 2016

(54) ROTATING MULTI-AXIS ILLUMINATED NOVELTY DEVICE

(71) Applicant: Group-JDS, Ltd.(HK), Kowloon (HK)

(72) Inventor: Christian Brayian Roos, Quito (EC)

(21) Appl. No.: 14/808,927

(22) Filed: Jul. 24, 2015

Related U.S. Application Data
(60) Provisional application No. 62/116,121, filed on Feb. 13, 2015.

(51) Int. Cl. F21V 21/30; F21V 23/04; F21V 21/14; F21V 21/40

(52) U.S. Cl. CPC F21V 21/30; F21V 21/406; F21V 23/0414; F21V 21/145; F21Y 2101/02

(57) ABSTRACT

A rotating multi-axis illuminated novelty device is provided. The illuminated novelty includes a base, a hub and an illumination device. The base includes a first driving element having a first shaft extending outwardly therefrom and driven to rotate on a first axis by the first driving element. The hub is connected to the first shaft to rotate therewith and includes a second driving element with a second shaft extending therefrom, the second shaft configured for rotation about a second axis extending in a different direction than the first axis. The illumination device is connected to the second shaft and rotatable therewith. The illumination device includes one or more illuminating elements.

### BACKGROUND

The following description relates to an illuminated novelty device, for example, an illuminated novelty device with one or more illumination devices rotatable about multiple axes.

Illuminated novelty devices may be used to provide visual effects for example, at parties or celebrations and the like, or as part of a performance or other artistic or entertainment endeavor. Some conventional illuminated novelty devices may be large, cumbersome or difficult to move. Others may need to be connected to an external power source, such a standard wall outlet via a plug for operation.

In addition, conventional illuminated novelty devices may be limited in the visual effects they are capable of providing. For example, some such devices include stationary lights or other illuminated features. To provide a dynamic or “moving” effect, a user must physically move the device. Other such devices may incorporate a strand of blinking lights or illuminated members that may blink or illuminate in sequence to provide the effect of a moving light. However, this moving effect is limited to a path of the strand of lights. Further, such a configuration may result in excess lights or illuminating members on the device.

Some illuminated novelty devices may include moving lights or illuminated features that are driven along a travel path. However, this “moving” visual effect is typically limited to a travel path about a single axis.

Accordingly, it is desirable to provide an illuminated novelty device that is portable and may provide a dynamic and variable visual effect.

### SUMMARY

According to one embodiment, there is provided a rotating multi-axis illuminated novelty device. The illuminated novelty device includes a base having a first driving element, the first driving element having a first shaft extending outwardly therefrom and driven to rotate on a first axis by the first driving element. The device also includes a hub operably connected to the first shaft to rotate therewith, the hub having a second driving element with a second shaft extending therefrom, the second shaft configured for rotation about a second axis extending in a different direction than the first axis. The device further includes an illumination device operably connected to the second shaft and rotatable therewith. The illumination device includes one or more illuminating elements.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a perspective view of an illuminated novelty device according to an embodiment described herein;

FIG. 2 is a front view of the illuminated novelty device of FIG. 1;

FIG. 3 is a side view of the illuminated novelty device of FIG. 1;

FIG. 4 is a side view of the illuminated novelty device of FIG. 1 partially disassembled to show interior components;

FIG. 5 is a partially disassembled front view of the illuminated novelty device of FIG. 1 showing interior components, according to an embodiment described herein;

FIG. 6 is a partially disassembled front view of the illuminated novelty device of FIG. 1 showing additional interior components;

FIG. 7 is a cut-away perspective view showing a hub of the illuminated novelty device of FIG. 1, according to an embodiment described herein;

FIG. 8 is partially disassembled top view of the illuminated novelty device of FIG. 1 showing interior components;

FIG. 9 is a partially disassembled top view of the illuminated novelty device of FIG. 1 showing additional interior components;

FIG. 10 is a front view of the illuminated novelty device according to another embodiment described herein; and

FIG. 11 is a side view of the illuminated novelty device of FIG. 9.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

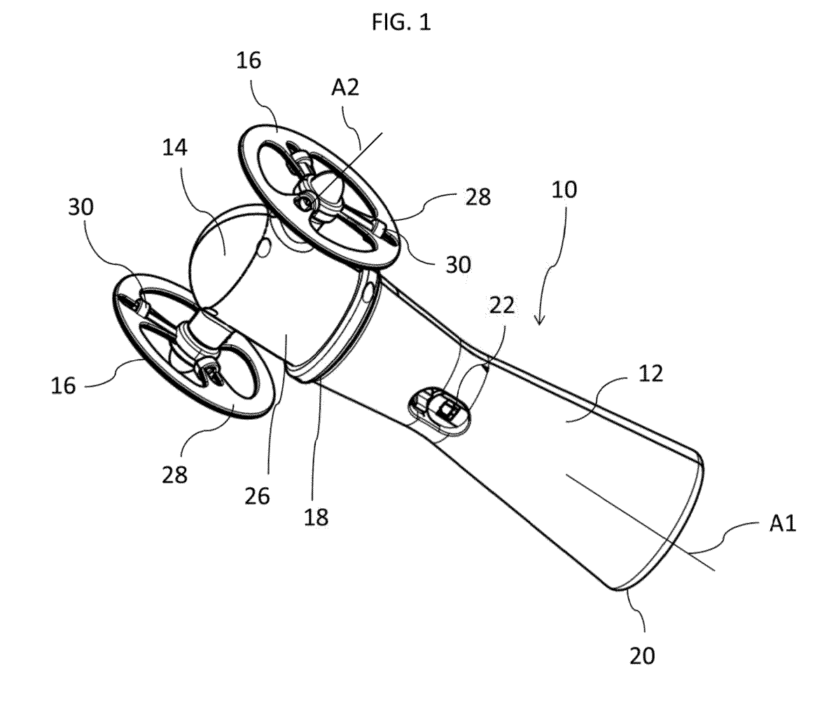

FIG. 1 is a perspective view of an example of an illuminated novelty device 10 described herein. According to one embodiment, the illuminated novelty device 10 generally includes a base 12, a hub 14 rotatably positioned relative to the base 12 and configured to rotate about a first axis A1, and one or more illumination devices 16 rotatably positioned relative to the hub 14 and configured to rotate about a second axis A2, angled relative to the first axis A1. The one or more illumination devices 16 may rotate about second axis A2 simultaneously with the hub 14 rotating about the first axis A1.

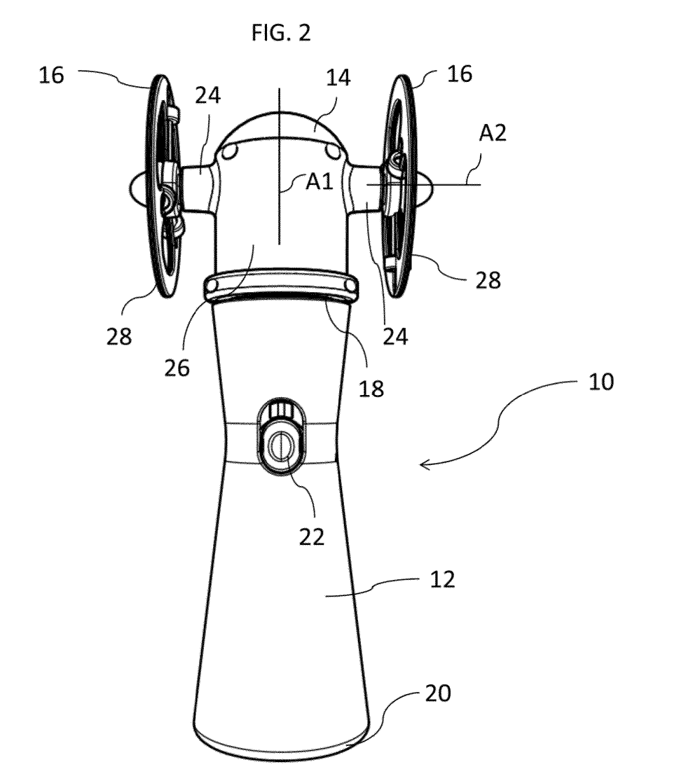

FIG. 2 is a front view of the illuminated novelty device 10 of FIG. 1. Referring now to FIGS. 1 and 2, the base 12 may be formed as a hand grip configured to be held by a user of the illuminated novelty device 10. In one embodiment, the base 12 may be ergonomically shaped so as to be accommodated in the user's hand. For example, the base 12 may be substantially cylindrical in shape and formed with a concavity along its length, such that a diameter at first and second opposing ends 18, 20 of the base 12 is greater than a diameter at a section between the first and second end 18, 20. In addition, the base 12 may include one or more indentations or finger grips formed at spaced apart intervals around a circumference of the base 12. The base 12 may be formed with a removable cover or as adjoining halves or sections to allow access to interior components of the base 12.

The illuminated novelty device 10 may also include a switch 22. In one embodiment the switch is positioned on the base 12 and may be actuated to operate the illuminated novelty device 10 as described further below. The switch 22 may be, for example, a rocker switch, a slidable switch, a push button, a rotatable knob or other suitable switch.

With further reference to FIGS. 1 and 2, the hub 14 includes one or more arms 24, each arm having a respective illumination device 16 positioned thereon. In one embodiment, for example, as shown in FIGS. 1 and 2, the hub 14 includes two arms 24. In one configuration, the arms 24 are diametrically opposed and extend on or along the second axis A2.

The second axis A2 may extend perpendicular or substantially perpendicular to the first axis A1, but is not limited only to this range. The hub 14 may also include a cover 26.

Although the illustrated embodiments show two arms 24 extending from the hub 14, it is understood that the present disclosure is not limited to this configuration. For example, in one embodiment, a single arm 24 may extend from the hub 14 to support a single illumination device 16. In another non-limiting embodiment, four arms 24 may extend from the hub. In such a configuration, the four arms 24 may be positioned so as to form two diametrically opposing pairs of arms 24, each arm 24 supporting a respective illumination device 16. Further, it is understood that the one or more arms 24 may extend from the hub 14 at different or varying angles.

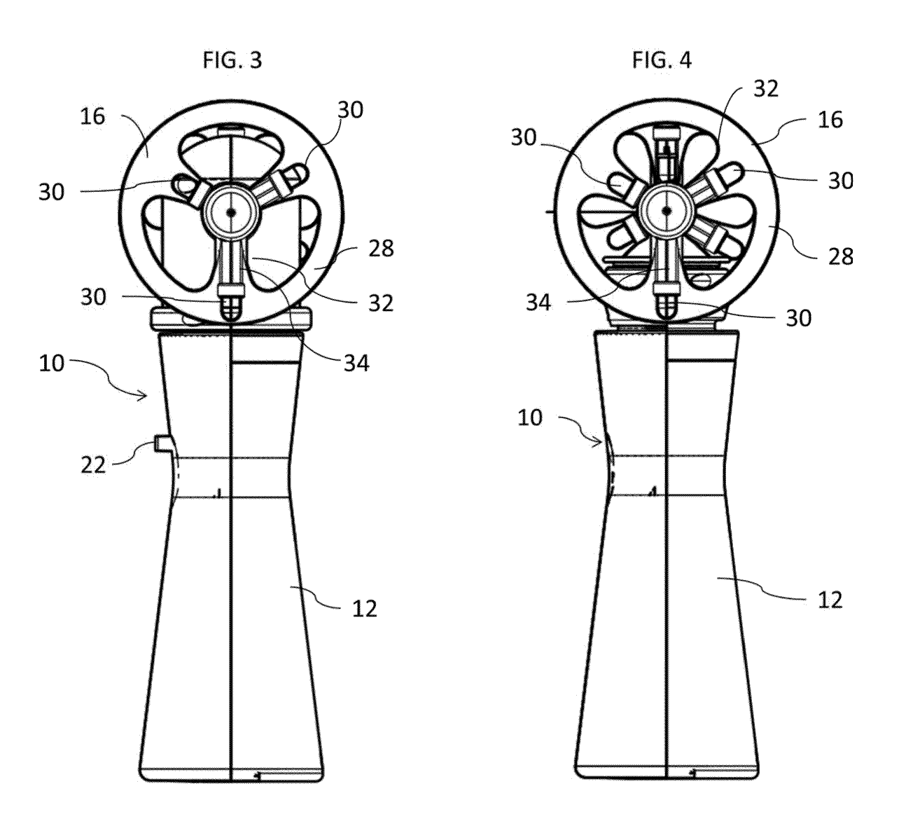

FIG. 3 is a side view of illuminated novelty device 10 of FIG. 1. Referring to the embodiment shown in FIG. 3, each illumination device 16 includes a frame 28 and one or more illuminating elements 30. In one embodiment, each illumination device 16 includes three illuminating elements 30. However, it is understood that the present disclosure is not limited to this configuration and the number of illuminating elements 30 may be varied. In addition, different illumination devices 16 on the illuminated novelty device 10 may include different numbers of illuminating elements 30.

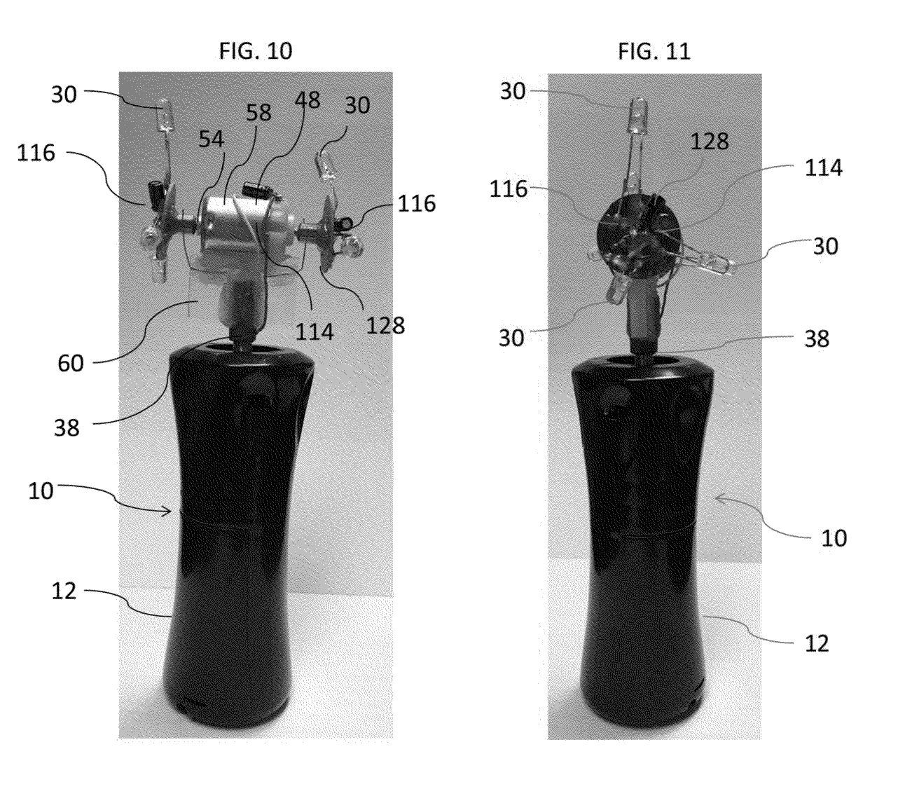

In one embodiment, each frame 28 may be formed substantially in a circular shape with one or more spokes 32 extending from an inner radial section to an outer radial section. The one or more illuminating elements 30 extend radially outward relative to a respective arm 24. In one embodiment, the illuminating elements 30 extend within, along, and/or secured to a spoke of a frame 28. In another embodiment, as detailed further below with reference to FIGS. 9 and 10, the frame 28 may be formed substantially as a plate and the one or more illuminating elements 30 may be secured to and extend outward from the plate, for example, in a radial direction.

Referring still to FIG. 3, the illuminating elements 30 may be angularly spaced. In one embodiment, the illuminating elements 30 may be equally spaced about the illumination device 16. However, it is understood that this description is not limited to such a configuration. In addition, the illuminating elements 30 may extend radially outward to different radial extents. The radial length of the illuminating elements 30 may be varied by varying a length of a neck portion 34 of each illuminating element 30. Further still, in some embodiments, the illuminating elements 30 of an illumination device 16 may extend in a common plane.

Each illuminating element 30 of the one or more illuminating elements 30 may be implemented as individual light emitting diodes (LEDs) or closely positioned LEDs contained in a common casing or shell. The LEDs may be multi-colored and emit different colors during use. That is, a single illuminating element 30, such as an LED, may emit multiple colors with respect to time. It is understood, however, that the present disclosure is not limited to these examples. For instance, the one or more illuminating elements 30 may be implemented as strands of LEDs, or alternatively, may be formed from a chemiluminescent material or mixture, or the like. Further still, the illuminating elements 30 may be implemented as incandescent lights, or the like. The illuminating elements 30 may also be formed as fiber optic lighting elements formed as thin, elongated tubes configured to reflect internally directed light to create a visual effect. The internally directed light may be from an LED or other similar light source.

The novelty illumination device 16 may also include a board having electronic control circuitry (e.g., a controller) printed thereon. The illuminating elements 30 may be electrically connected to the control circuitry. Accordingly, in use, the control circuitry may operate the illumination device(s) 16 to, for example, change a color of the emitted light in a desired, controlled, or preprogrammed sequence, to remain on, to blink or to illuminate in a predetermined timed pattern. The control circuitry may be integrated in the frame 28.

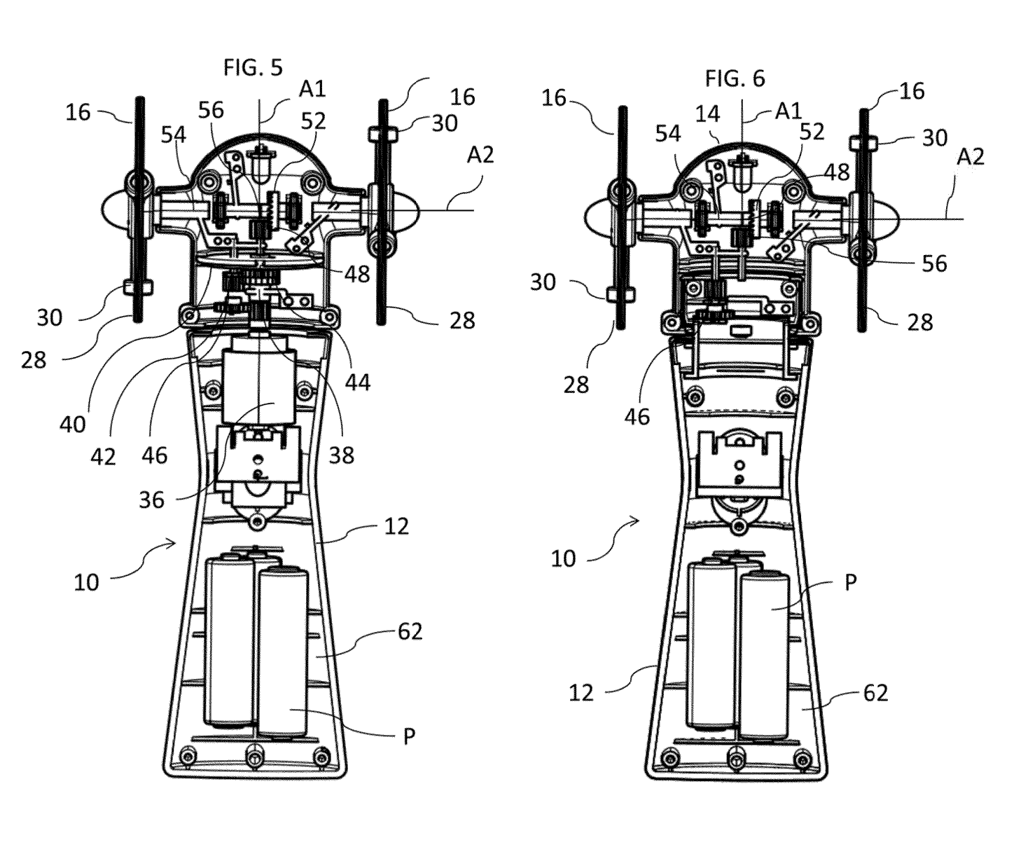

FIG. 4 is a side view of the illuminated novelty device 10 of FIG. 1, according to an embodiment described herein. In FIG. 4, the cover 26 of the hub 14 is removed to partially show interior components. FIG. 5 is a partially disassembled view of the illuminated novelty device 10 of FIG. 1 showing interior components of the device 10 in the base 12 and the hub 14, according to an embodiment described herein.

Referring to FIGS. 4 and 5, the novelty illumination device 16 includes a first driving element 36 configured to rotate the hub 14, and in turn, the one or more illumination devices 16 on or about the first axis A1. The first driving element 36 is positioned at least partially within and secured to the base 12 and includes a first shaft 38. The first shaft 16 is rotatably driven on or about the first axis A1 by the first driving element 36 and is connected the hub 14 to rotatably drive the hub 14 on or about the first axis A1.

FIG. 6 is another section view of the illuminated novelty device 10 showing interior components, with the first driving element 36 omitted for clarity. Referring to FIGS. 4-6, the hub 14 may be connected to the driving element 36 and the first shaft 38 so as to be driven to rotate by the first driving element 36 and the first shaft 38. For example, in one embodiment, the hub 14 may be connected to the first driving element 36 and first shaft 38 by a gear train 42. In one embodiment, as shown in FIG. 5, for example, the gear train 42 may include a fixed gear 44 positioned on, and rotatable with the first shaft 38. The gear train 42 may further include a gear 46 eccentrically positioned on, and connected to, the hub 14. The fixed gear 44 and the eccentrically positioned gear 46 may be position in meshed engagement, such that rotation of the fixed gear 44 causes the eccentrically positioned gear 46 to rotate about the first axis A1, which in turn causes rotation of the hub disk or body 40 on the first axis A1. The hub cover 26 may be fixedly secured to the hub disk or body 40 to rotate therewith. The hub 14 may also be rotatably connected or coupled to the base 12 by way of a rotational bearing assembly, such as a ball or roller bearing assembly.

The present disclosure is not limited to such a configuration, however. For example, the first shaft 38 may be keyed to the hub disk or body 40 to cause the hub disk or body 40 to rotate with the first shaft 38, and the gear train 42 may be omitted.

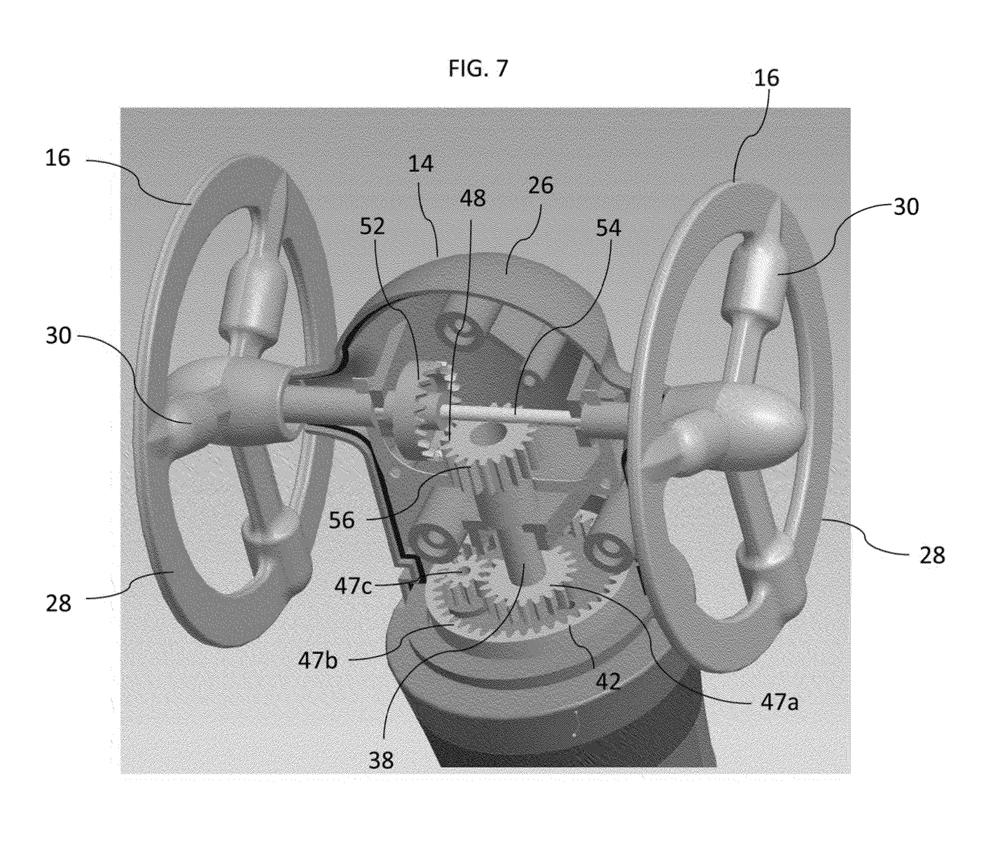

The gear train 42 may be implemented in alternative configurations as well. FIG. 7 is a cut-away perspective view showing interior components of the hub 14 according to another embodiment described herein. Referring to FIGS. 5-7, the gear train 42 may be implemented as a planetary gear system. That is, the first shaft 38 and the first driving element 36 may be connected to the hub 14 by way of a planetary gear system. For example, as shown in FIG. 7, the gear train 42 may include a sun gear 47a fixedly connected to the first shaft 38 to rotate therewith, a ring gear 47b fixed connected to the hub 14, and a planet gear 47c between the sun gear 47a and ring gear 47b. It is understood the present disclosure is not limited to the configurations detailed above, and that other similar or known configurations may be used to rotatably couple the hub 14 to the base 12.

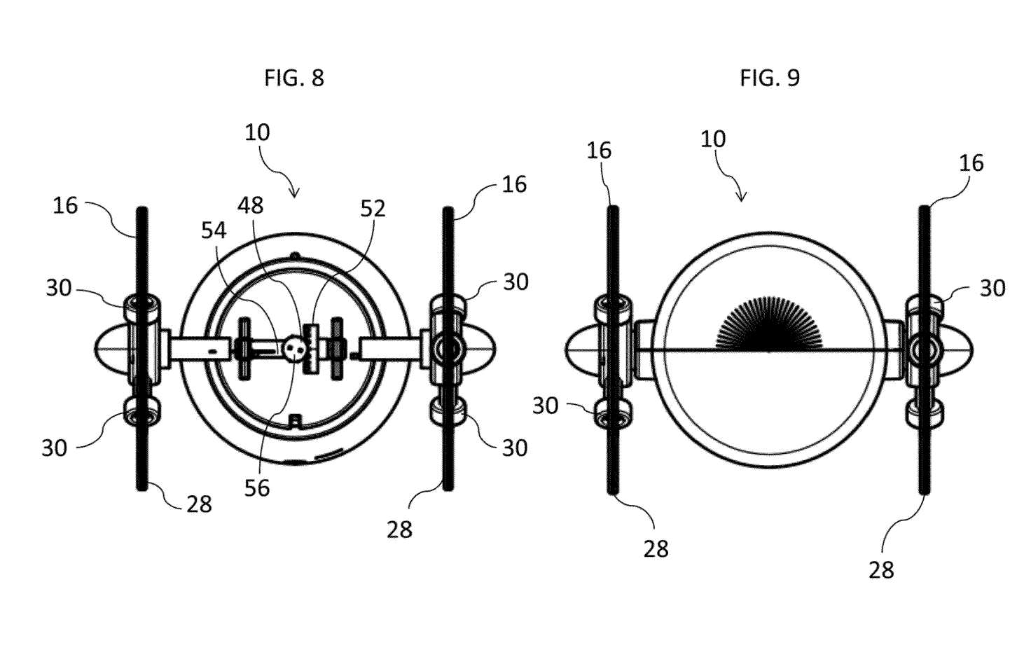

FIG. 8 is a top view of the illuminated novelty device with the hub cover 26 removed to show interior components, according to an embodiment described herein. Referring to FIGS. 5-8, the illuminated novelty device also includes a second driving element 48 configured to rotate the one or more illumination devices 16 about the second axis A2. In one embodiment, the second driving element 48 is formed as a gear drive. The gear drive may include a first gear plate 52 connected to a second shaft 54 and configured to rotate on the second axis A2. The first gear plate 52 meshes with a second gear plate 56 positioned on the first axis A1. The meshed engagement between the first and second gear plates 52, 56 causes the second shaft 54 to rotate on the second axis A2 in response to relative rotation between the first and second gear plates 52, 56.

It is understood that the second gear plate 56 may be driven to rotate by the first shaft 38. Alternatively, the second gear plate 56 may be stationary, decoupled from the first shaft 38, and the first gear plate 52 may be driven around the first axis A1 via a connection between the second shaft 54, the arms 24 and the cover 26. That is, the cover 26 may be driven to rotate on the first axis A1 as described above. Rotation of the cover 26, and in turn the arms 24, may cause the second shaft 54 and the first gear plate 52 to rotate on or about the first axis A1. The meshed engagement between the first gear plate 52 and the second gear plate 56 may then cause the first gear plate 52, and in turn, the second shaft 54, to rotate on the second axis A2.

It is understood that other similar gear couplings suitable to convert rotation from one axis to a different axis may be incorporated. FIG. 9 is a top view of hub 14 showing a cut-away section having a variation of the driving gear 56 that may be used to drive the driven gear 52 in a known manner.

The second shaft 54 may be formed as a single shaft extending across the hub 14 and into the one or more arms 24. The one or more illumination devices 16 are connected to the second shaft 54 to rotate together with the second shaft 54. In one embodiment, the one or more illumination devices 16 are connected to the second shaft 54 at an open end or portion of the respective one or more arms 24.

In another embodiment, the second shaft 54 may include two or more decoupled sections and the second drive mechanism may include two or more first gears 52 meshed with the second gear 56, each first gear 52 associated with a second shaft 54 section. In this embodiment, rotation of individual shaft sections may be independently controlled based on gear ratios. It is understood that the present disclosure is not limited to the configurations described above. For example, the individual sections of the second shaft 54 may extend from adjacent sides, or may be angled relative to one another at a non-zero or non-180 degree angle. Depending on the gear configuration, the shaft sections may be controlled to rotate in the same or opposite directions from one another, as desired.

In the embodiments above, the first driving element 14 may be, for example, an electric motor, or the like. In addition, the second driving element 28, as described above, may be a gear drive. However, the present disclosure is not limited to this configuration.

FIGS. 10 and 11 show front and side views of the illuminated novelty device according to an alternative embodiment. Further discussion of features similar or identical to those detailed in the embodiments above is omitted. It is understood that various features from the following embodiments may be used together with or in place of various features detailed in the embodiments above, and vice versa.

Referring to FIGS. 10 and 11, the second driving element 48 may alternatively be one or more second electric motors 58. A single second electric motor 58 may drive the second shaft 54, or, alternatively, individual second electric motors 58 may independently drive separate, decoupled sections of the second shaft 54. In this embodiment, the one or more second electric motors 58 may form the hub 114. The one or more second electric motors 58 are connected to the first shaft 38 so as to rotate therewith. Accordingly, the first shaft 38 may rotate the one or more second electric motors on or about the first axis A1 and the one or more second motors 58 may rotate the second shaft 54 on or about the second axis A2.

With further reference to FIGS. 10 and 11, the frame 128 of each illumination device 116 may be formed as plate-shaped member to which the one or more illuminating elements 30 are secured and from which the illuminating elements 30 extend radially outward. Although not depicted in FIGS. 10 and 11, it is understood that the hub cover 26 described above may be included to house the one or electrical motors and at least a portion of the second shaft 54. The hub 114 may also include an additional support structure 60. The support structure 60 may rotate with the first shaft 38 and be connected to the second driving element 48 over a greater area than the first shaft 38. Thus, the support structure 60 may provide a stronger coupling, by way of increased contact area, and may also serve to stabilize the second driving element 48 on the first shaft 38 in use. In the embodiments above, the hub 14 including the second driving element 48 and the second shaft or shafts 54 may rotate together about the first axis A1, being driven by the first driving element 36.

In the embodiments above, as shown in FIGS. 5 and 6, for example, the base 12 may further include electrical connectors for electrically connecting to and receiving power from a power supply P. The power supply P may be, for example, a battery, batteries or battery pack or a thin film battery. The power supply may be rechargeable. Other similar and suitable power supplies apparent to those having skill in the art may be implemented as well. In one example, the power supply may be a standard electrical supply received from a wall socket. Accordingly, in the embodiments above, the electrical connectors may be, for example, contacts or leads configured to engage a battery terminal or wire, a positive interlocking electrical connection formed by a mating pair of heads, or a cord or plug configured to extend from base to engage a corresponding wall socket. It is understood that the present description is not limited to these example and that other suitable electrical connections known to those having skill in the art may be implemented as well.

The base 12 may include a housing or receptacle 62 configured to receive the power supply P. The power supply P is electrically connected to the first driving element 14, the illumination devices 16 and illuminating elements 30. The power supply P may also be electrically connected to the second driving element 48. The electrical connections between these elements may be of a suitable type commonly used in the art, such as electrical contact connections. The switch 22 may be provided on the base 12 may be actuated, for example, between ON and OFF positions to selectively supply current from the power supply P to the first driving element 36, the one or more second electric motors 58, the illumination devices 16, the controller, and/or illuminating elements 30.

In operation, the first driving element 36 may rotate the first shaft 38 on the first axis A1. Accordingly, the hub 14, second shaft 54, one or more illumination devices 16 and one or more illuminating elements 30 may be rotated on or about the first axis A1. Additionally, the second driving element 48 may drive the second shaft 54 to rotate on the second axis ‘A2’. Accordingly, the one or more illumination devices 16 and one or more illuminating elements 30 may be driven to rotate about the second axis A2 while simultaneously rotating about the first axis A1.

In the above embodiments, a hand-held, portable illuminated novelty device may be provided. The illuminated novelty device may provide a unique visual effect resulting from the multi-axis rotation and positioning of the illuminating elements 30. For example, by rotating the illuminating elements 30 simultaneously about two axes, a visual effect may be provided where individual illuminating elements may appear to form corresponding trails, lines or arcs of light travelling along substantially spherical surfaces of differing radii.

It should also be understood that various changes and modifications to the presently disclosed embodiments will be apparent to those skilled in the art. Such changes and modifications can be made without departing from the spirit and scope of the present disclosure and without diminishing its intended advantages. It is therefore intended that such changes and modifications be covered by the appended claims.

1. A rotating multi-axis illuminated novelty device comprising:
a base having a first driving element, the first driving element having a first shaft extending outwardly therefrom and driven to rotate on a first axis by the first driving element;
a hub operably connected to the first shaft to rotate therewith, the hub having a second driving element with a second shaft extending therefrom, the second shaft configured for rotation about a second axis extending in a different direction than the first axis; and
an illumination device operably connected to the second shaft and rotatable therewith, the illumination device comprising one or more illuminating elements.

2. The illuminated novelty device of claim 1, wherein the illumination device further comprises a frame connected to rotate with the second shaft.

3. The illuminated novelty device of claim 2, wherein the frame includes electronic control circuitry to which the one or more illuminating elements are electrically connected.

4. The illuminated novelty device of claim 2, wherein the frame includes a radial outer ring and one or more spokes extending radially within the outer ring.

5. The illuminated novelty device of claim 2, wherein the one or more illuminating elements extend along a respective spoke of the one or more spokes.

6. The illuminated novelty device of claim 2, wherein the frame is a disk-shaped member.

7. The illuminated novelty device of claim 6, wherein the one or more illuminating elements extend radially outward from the disk-shaped member.

8. The illuminated novelty device of claim 2, wherein the one or more illuminating elements includes two or more illuminating elements.

9. The illuminated novelty device of claim 8, wherein the two or more illuminating elements extend different radial distances relative to the second shaft.

10. The illuminated novelty device of claim 9, wherein the two or more illuminating elements includes three illuminating elements.

11. The illuminated novelty device of claim 1, comprising two illumination devices.

12. The illuminated novelty device of claim 11, wherein the two illumination devices are positioned diametrically opposite from one another.

13. The illuminated novelty device of claim 1, wherein the first driving element is a first electric motor.

14. The illuminated novelty device of claim 1, wherein the second driving element is a second electric motor, and the second electric motor is rotatable with the first shaft.

15. The illuminated novelty device of claim 1, wherein the second driving element is a gear drive driven by the first shaft.

16. The illuminated novelty device of claim 1, wherein the base is formed as a hand grip configured to be held by a user.

17. The illuminated novelty device of claim 1, wherein the one or more illuminating elements are light emitting diodes.

18. The illuminated novelty device of claim 1, further comprising a switch to actuate the illuminated novelty device between an ON condition where current is supplied from an internal power supply to the first driving element and the illumination device, and an OFF condition where current is not supplied from the internal power supply to the first driving element and the illumination device.

19. The illuminated novelty device of claim 13, wherein in the ON condition, current is further supplied to the second driving element.

20. The illuminated novelty device of claim 1, wherein the hub further comprises a hub cover.
